(19) United States
(12) Patent Application Publication
(10) Pub. No.: US 2012/0246516 A1
(43) Pub. Date: Sep. 27, 2012

(54) METHOD AND DEVICE FOR TESTING THE CONFIGURATION OF A COMPUTER SYSTEM

(75) Inventors: Christian Stich, Hirschberg-Leutershausen (DE); Marcel Dix, Mannheim (DE); Mikael Rudin, Vasteras (SE); Sylvia Maczey, Hirschberg (DE)

(73) Assignee: ABB Technology AG, Zurich (CH)

(21) Appl. No.: 13/434,352

(22) Filed: Mar. 29, 2012

Related U.S. Application Data
(63) Continuation of application No. PCT/EP2010/005843, filed on Sep. 24, 2010.

(30) Foreign Application Priority Data
Sep. 29, 2009 (DE) 10 2009 043 286.8

(51) Int. Cl. G06F 11/22

(52) U.S. Cl. 714/37; 714/E11.148

(57) ABSTRACT

An exemplary system and method for testing the configuration of a computer system includes detecting a function which is executed by the computer system; and testing whether the detected function contravenes a configuration rule of the computer system.

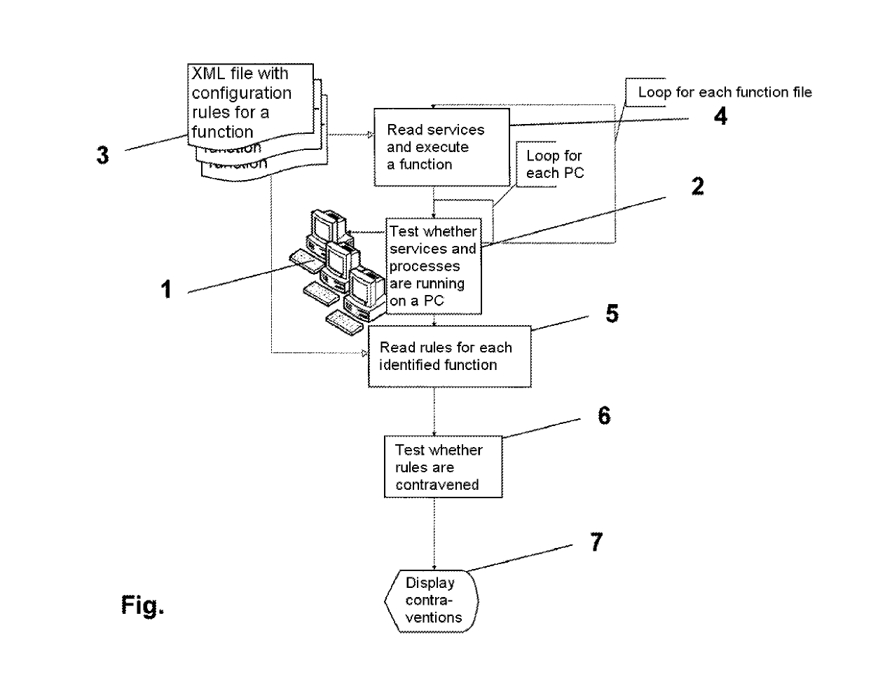

### RELATED APPLICATION

This application claims priority as a continuation application under 35 U.S.C. §120 to PCT/EP2010/005843, which was filed as an International Application on Sep. 24, 2010 designating the U.S., and which claims priority to German Application 10 2009 043 286.8 filed in Germany on Sep. 29, 2009. The entire contents of these applications are hereby incorporated by reference in their entireties.

### FIELD

The invention relates to a computer system, such as a method and a device for testing the configuration of a computer system.

### BACKGROUND

In known industrial practices, a plurality of computers can be connected to one another in networks or distributed computer systems. An important task in heterogeneous distributed or networked computer systems is to safeguard a consistent configuration, namely the controlled sequence of desired functions.

If a particular function is intended to take place, it must be activated. This means that all services and sequences belonging to this function must be executed. However, functions may also be omitted or canceled, namely if the execution of the associated sequences, services or executables is stopped.

Therefore, there is a need to enable suitable program packages, for example services and executables which are distributed over the computer system, to reliably activate required functions.

Against this background, the executability of a specific function is ensured by executing a plurality of program packages on one or more computers. However, these program packages are often influenced by dependencies and constraints or restrictive rules.

There are usually restrictions with regard to dependencies and constraints or restrictive rules of the functions among one another. Functions sometimes exclude one another on the same computer or in the entire computer system. Some restrictions may be aimed at the number in which a particular function must be present in a computer system.

Therefore, impairments can very easily result and severely disrupt the sequence of desired functions. Consequently, the desired configuration of a computer system can be easily disrupted.

The methods and devices known from the prior art make it possible to monitor a computer system for the sequence of permissible and desired functions only to an insufficient extent. Furthermore, it has hitherto been possible to determine and restore the configuration of a computer system only to an insufficient extent.

### SUMMARY

An exemplary method for testing the configuration of a computer system is disclosed, comprising: detecting a function which is executed by the computer system; and testing whether the detected function contravenes a configuration rule of the computer system.

An exemplary device for testing the configuration of a computer system is disclosed, comprising: hardware which detects a function, that is executed by the computer system, and tests whether the detected function contravenes a configuration rule of the computer system.

### BRIEF DESCRIPTION OF THE DRAWINGS

In the drawing:

The FIGURE shows a schematic illustration of a diagram for carrying out the method.

### DETAILED DESCRIPTION

Exemplary embodiments disclosed herein specify a method and a device which can be used to test the configuration of a computer system without any problems and in a reliable manner.

According to an exemplary embodiment of the present disclosure a method for testing the configuration of a computer system includes the steps of: detecting a function which is executed by the computers of the computer system or by the computer system, and testing whether the detected function contravenes a configuration rule of the computer system.

An exemplary method according to the present disclosure includes two steps. The first step involves querying functions which are assigned to the computer system, in particular a distributed computer system. The second step involves testing whether the functions found contravene a predefined configuration rule for the distribution of the functions. According to the disclosure, it was initially recognized that complex computer systems should provide reliable monitoring with regard to their current configuration. It was then recognized that the configuration or consistency rules must be continuously compared with the current configuration in order to ensure proper operation of the computer system. It was also recognized that the configuration state can be determined, using the currently running functions. It was further recognized that an exemplary method of the present disclosure makes it possible to reliably test a computer system for its configuration and the sequence of desired functions without any problems. The object mentioned at the outset is consequently achieved.

The function is advantageously detected by detecting services and sequences running on the computers. The respective function is uniquely identified by the services and sequences.

In another exemplary embodiment, the detected services and sequences are compared with services and sequences which should be executed on one or more computers in order to carry out a function. This makes it possible to compare the detected services and sequences with already known services and sequences. It is possible to determine without a doubt whether a particular function is currently being executed by the computer system, in particular a distributed computer system.

The exemplary services and sequences which should be executed on one or more computers in order to carry out the function can be listed in a functional description assigned to this function. This functional description lists all of the services and sequences which should be executed on one or more of the computers of the distributed or networked computer system in order to carry out the function. The functional description can be accessed at any time. The functional description is advantageously stored in a permanent memory of an apparatus for carrying out the method described here.

The current configuration is advantageously determined after the function has been detected, in which case a test is then carried out in order to determine whether the detected function is in accordance with the configuration rules. The method described here describes a sequence for searching a computer network in order to identify the functions of a distributed or networked computer system and to compare the identified configuration with configuration rules. Therefore, an actual state can be compared with a desired state.

Against this background, the configuration rules which relate to the function can be listed in a functional description assigned to this function. The functional description therefore contains all configuration or consistency rules which relate to the respective function.

The functional description can be written in the XML format. Any function which can be executed by the distributed or networked computer system is described in a functional description which is assigned to said function and is in the XML format. The XML format is a known format and is easily available to experts.

A functional description can be created for each function. As a result, for each function which can be executed by the computer system, a separate functional description is a known aspect of the function and can be accessed. The functional description stores all data relating to the function, such as associated services and sequences and configuration rules.

According to an exemplary embodiment of the present disclosure, exclusion rules can be used as configuration rules. These rules stipulate that some functions must not be combined with certain other functions, to be precise neither in the same node or computer nor in the entire network or computer system.

In another exemplary embodiment of the present disclosure, rules of the dependencies can be used as configuration rules. These rules stipulate that the assignment of a function to a node or a computer implies the assignment of particular further functions, to be precise either in the same node or computer or somewhere else within the network or within the computer system.

In another exemplary embodiment disclosed herein, cardinality rules can be used as configuration rules. These rules restrict the number in which a function occurs within the network or the computer system.

Contraventions of the configuration rules can be displayed. This immediately alerts monitoring staff to possible faults in the computer system.

In another exemplary embodiment of the present disclosure, contraventions of the configuration rules are rectified in an automated manner. This makes it possible to prevent faults as quickly as possible.

Exemplary embodiments of the present disclosure include means of a device for testing the configuration of a computer system, which device includes hardware which detects a function, which is executed by the computers of the computer system or by the computer system, and tests whether the detected function contravenes a configuration rule of the computer system.

In order to avoid repetitions with regard to the inventive step, reference is made to the statements made with respect to the method.

The exemplary device (e.g., system) can carry out all of the method steps of the method described here individually or in combination.

The exemplary method described in the present disclosure can identify the functions assigned to each network node by comparing its sequences and services with the sequences and services listed in the available functional descriptions. The configuration or consistency of the tested system is then tested by applying the configuration or consistency rules found in the functional description to the distribution of the functions within the network.

In order to carry out the first step, which services and sequences belong to a respective function to be sought should be determined. The list of services and sequences is compared with the services and sequences running on the different computers. If all services and sequences which belong to a function are running, the respective function is identified. The type of test for determining whether a service or a sequence is running depends on the operating system. If Microsoft Windows services are used, Microsoft provides a routine library which handles testing.

In order to carry out the second step of the method, testing the configuration or consistency, two types of input data must be provided. The first type of input data includes the current configuration which results from carrying out an initial step of the method. The second type of input data includes the list of restrictions formulated as rules for the different functions. A special control component uses the two types of input data in order to apply these rules to the configuration.

The FIGURE schematically shows a method for testing the configuration of a computer system using a diagram in accordance with an exemplary embodiment.

The method includes the step of detecting a function which is executed by the computers 1 of the computer system or by the computer system. This is shown in block 2.

The first step is carried out by first of all detecting the services and sequences running on the computers 1 according to block 2.

The services and sequences which necessarily have to run on one or more computers 1 in order to carry out a function are listed in a functional description 3. The functional description 3 is written in the XML format. The services and sequences described there are read in according to block 4.

The detected services and sequences are compared with the services and sequences which necessarily have to run on one or more computers 1 in order to carry out a function. This is likewise effected in block 2.

If the detected services and sequences correspond to the services and sequences which have been read in, a particular function is uniquely identified. The identified function or functions define(s) the actual configuration state of the computer system.

The configuration rules which relate to the respective detected or identified function are likewise listed in the functional description 3 assigned to said function. The functional description 3 is written in the XML format. The rules described there are read in according to block 5.

The exemplary method can also include testing whether the detected function contravenes a configuration rule of the computer system. This is schematically illustrated in block 6.

The current configuration of the computer system is first of all determined after the function has been detected, in which case a test is then carried out in order to determine whether the detected function is in accordance with the configuration rules which have been read in.

Possible contraventions of the configuration rules are displayed according to block 7.

An arrangement (e.g., system) (not shown) includes the computers 1 and a device for testing the configuration of a computer system, which device has hardware which detects a function, which is executed by the computers of the computer system or by the computer system, and tests whether the detected function contravenes a configuration rule of the computer system.

With regard to further advantageous refinements and developments of the teaching according to the exemplary embodiments of the present disclosure, reference is made, on the one hand, to the general part of the description and, on the other hand, to the patent claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Computer
2 Block 2
3 Functional description
4 Block 4
5 Block 5
6 Block 6
7 Block 7

What is claimed is:

1. A method for testing the configuration of a computer system, comprising:
detecting a function which is executed by the computer system; and
testing whether the detected function contravenes a configuration rule of the computer system.

2. The method as claimed in claim 1, wherein the function is detected by detecting services and sequences running on the computers.

3. The method as claimed in claim 2, wherein the detected services and sequences are compared with services and sequences which necessarily have to run on one or more computers in order to carry out the function.

4. The method as claimed in claim 3, wherein the services and sequences which necessarily have to run on one or more computers in order to carry out the function are listed in a functional description assigned to this function.

5. The method as claimed in claim 1, wherein the current configuration is determined after the function has been detected, in which case a test is then carried out in order to determine whether the detected function is in accordance with the configuration rules.

6. The method as claimed in claim 1, wherein the configuration rules which relate to the function are listed in a functional description assigned to this function.

7. The method as claimed in claim 4, wherein the functional description is written in the XML format.

8. The method as claimed in claim 4, wherein a functional description is created for each function.

9. The method as claimed in claim 1, wherein exclusion rules are used as configuration rules.

10. The method as claimed in claim 1, wherein rules of the dependencies are used as configuration rules.

11. The method as claimed in claim 1, wherein cardinality rules are used as configuration rules.

12. The method as claimed in claim 1, wherein contraventions of the configuration rules are displayed.

13. The method as claimed in claim 1, wherein contraventions of the configuration rules are rectified in an automated manner.

14. The method as claimed in claim 1, wherein the function is executed by computers of the computer system.

15. A device for testing the configuration of a computer system, comprising:
hardware which detects a function, that is executed by the computer system, and tests whether the detected function contravenes a configuration rule of the computer system.

16. The device as claimed in claim 15, wherein contraventions of the configuration rules are rectified in an automated manner.

17. The device as claimed in claim 15, wherein the function is executed by computers of the computer system.
